(19) United States
(12) Patent Application Publication
(10) Pub. No.: US 2011/0051019 A1
(43) Pub. Date: Mar. 3, 2011

(54) EDGE LIGHTING CONTROL

(75) Inventors: Robert Hardacker, Escondido, CA (US); Rafael Calderon, San Diego, CA (US); Steven Richman, San Diego, CA (US)

(73) Assignees: SONY CORPORATION, Tokyo (JP); SONY ELECTRONICS, INC., Parkridge, NJ (US)

(21) Appl. No.: 12/553,543

(22) Filed: Sep. 3, 2009

(51) Int. Cl. H04N 5/66

(52) U.S. Cl. 348/739; 348/E05.133

(57) ABSTRACT

An edge lighting control for a television set. A television set includes a display, an edge lighting bezel surrounding the display, a processor, and a memory component. The edge lighting bezel is operable to output light and its operation is user controllable, e.g., interaction between a GUI and a remote control. The processor controls the operation of the edge lighting bezel, e.g., dimming the output light and its color pattern, in response to user input. The memory component stores instructions and data for controlling the operation of the edge lighting bezel when processed by the processor. The edge lighting bezel may include a ring of light emitting diodes (LEDs) surrounding the display and a light pipe surrounding the ring. The ring is operable to emit light responsive to the user input and the light pipe is operable to transmit light emitted from the ring.

### TECHNICAL FIELD

Embodiments of the present invention relate to the field of electronics. More particularly, embodiments of the present invention relate to controlling edge lighting of a display unit.

### BACKGROUND ART

Generally, displays, e.g., television sets, are not considered as decorative items but rather functional. However, the appearance of a television set is becoming more important in light of new technologies and new uses and locations of television sets. For example, television sets are being used to display photo albums. Unfortunately, the mechanical bezel around the television set is typically not decorative.

Some have developed clear bezels with clear decorative edges to improve the appearance of television sets. However, the clear bezel is still incapable of being matched with the decor of the room, e.g., paint colors, chairs, tables, etc. Accordingly, television sets with clear bezels may still look not decorative, thereby lacking harmony with their surrounding decor.

In one conventional system, the bezel may change color based on the content being rendered by the television set. In other words, the content being rendered is processed and the color of the bezel changes based on the signal processing of the content. Unfortunately, the bezel does not render a color when the television is turned off. Thus, the conventional system that changes the color of the bezel is also not decorative when the television set is turned off. Moreover, the color rendered by the bezel or color operation itself are neither user selectable nor user controllable.

### SUMMARY

Accordingly, a need has arisen to control the edge lighting of a display, e.g., television set, to decoratively match the television set with the exiting decor of a room. Moreover, a need has arisen to enable a user to control the edge lighting operation of a television set. For example, it is advantageous to enable a user to control the color of the light output by the bezel despite the television set being turned off. It will become apparent to those skilled in the art in view of the detailed description of the present invention that the embodiments of the present invention remedy the above mentioned needs and provide the above referenced advantages.

According to one embodiment, a television set comprises an edge lighting bezel that surrounds a display, a processor, and a memory component. The display is operable to render images. The operation of the edge lighting bezel is user controllable. The processor is operable to process data for controlling the operation of the edge lighting bezel responsive to a user input. It is appreciated that the memory component may store instructions and data operable to control the operation of the edge lighting bezel when processed by the processor.

In one embodiment, the default mode of operation is that bezel lighting is turned off. The user interface with the television, via on-screen menu selections, to activate bezel lighting operations. It is appreciated that the edge lighting bezel may be disabled in default mode in order to conform with Energy Star Compliance requirements. It is appreciated that the edge lighting bezel may remain or be turned on even when the television set is turned off.

The operation of the edge lighting bezel may include controlling the color pattern of the light output, selecting the animation of the light output, selecting dimming of the light output, altering the light output responsive to detecting motion, controlling the timing of the light output of the edge lighting bezel, turning on/off the edge lighting bezel based on an event, etc. It is appreciated that the operation of the edge lighting bezel is user controllable and user selectable. For example, a user may interact with on-screen graphical user interfaces (GUIs) via a remote control to program to alter the operation of the edge lighting bezel.

In one embodiment, the edge lighting bezel may comprise a plurality of light emitting diodes (LEDs) in a ring that surround the display. The LED ring is operable to emit light responsive to a user input. The edge lighting bezel may further include a light pipe or other light diffusive materials surrounding the LED ring to transmit light emitted from the LED.

Accordingly, the operation of edge lighting of a television set may be controlled by a user. The operation of the edge lighting of the television set may be altered responsive to user preferences, e.g., based on the room decor. As such, a television set becomes not only functional but rather decorative and enhances the user experience by improving the room decor. Edge lighting also improves product differentiation.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 shows an exemplary television set in accordance with one embodiment of the present invention.

FIG. 2 shows an exemplary on-screen graphical user interface for controlling edge lighting of a television set in accordance with one embodiment of the present invention.

FIG. 3 shows an exemplary flow diagram for controlling edge lighting of a television set in accordance with one embodiment of the present invention.

FIG. 4 shows an exemplary television set in accordance with one embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

### Notation and Nomenclature

Some portions of the detailed descriptions which follow are presented in terms of procedures, steps, logic blocks, processing, and other symbolic representations of operations on data bits that can be performed on television set memory. These descriptions and representations are the means used by those skilled in the art to most effectively convey the substance of their work to others skilled in the art. A procedure, television set executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “creating” or “transferring” or “executing” or “determining” or “instructing” or “issuing” or “altering” or “clearing” or “accessing” or “aggregating” or “obtaining” or “selecting” or “calculating” or “measuring” or “querying” or “receiving” or “sending” or “providing” or “storing” or “displaying” or “rendering” or “scanning” or “detecting” or “prompting” or “dimming” or “changing” or the like, refer to the action and processes of a television set, or similar electronic computing device, that manipulates and transforms data represented as physical (electronic) quantities within the television set's registers and memories into other data similarly represented as physical quantities within the television set memories or registers or other such information storage, transmission or display devices.

### Edge Lighting Control

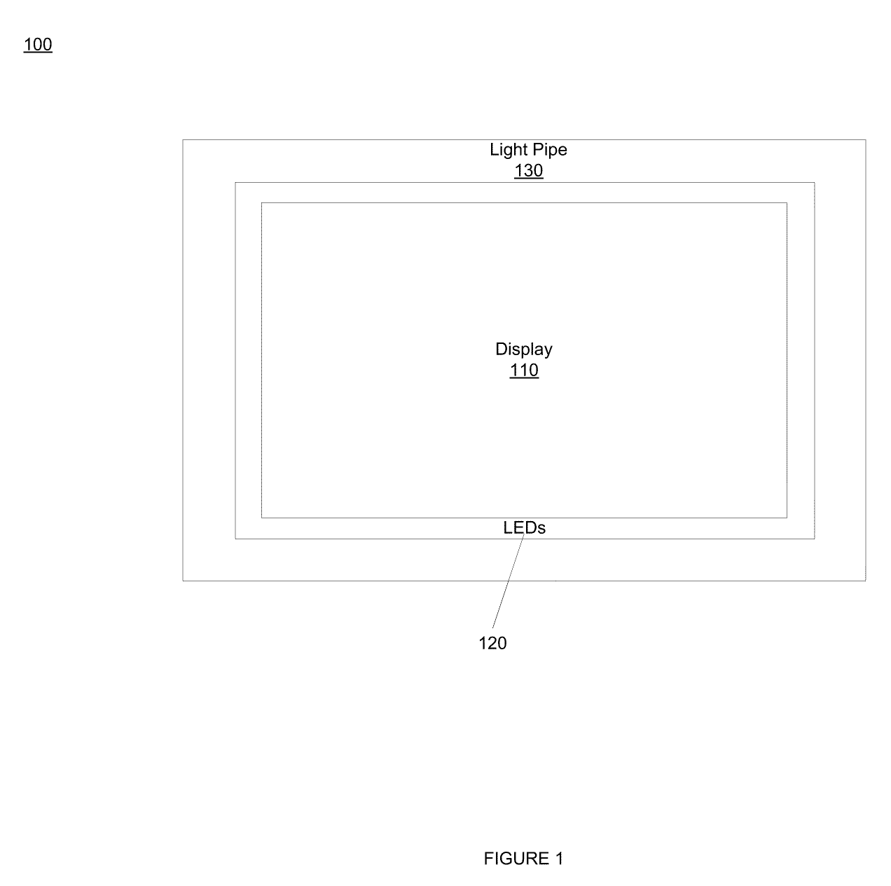

Referring to FIG. 1, a television set 100 in accordance with one embodiment of the present invention is shown. The television set 100 comprises a display 110 for rendering images, a plurality of light emitting diodes (LEDs) 120 surrounding the display 110, and a light pipe 130 that surrounds the plurality of LEDs 120. It is noted that the bezel of the television set, as referred to herein, includes the plurality of LEDs 120 and the light pipe 130. It is appreciated that the edge lighting control described herein with respect to a television set is exemplary and not intended to limit the scope of the embodiments of the present invention. For example, the edge lighting control may be used with any display having lighted bezel, e.g., a smart phone, a computer monitor, etc.

The display 110 is operable to render content, e.g., still images, frame images, animation, etc. It is appreciated that displaying content may be accompanied with the rendition of sound via speakers (not shown).

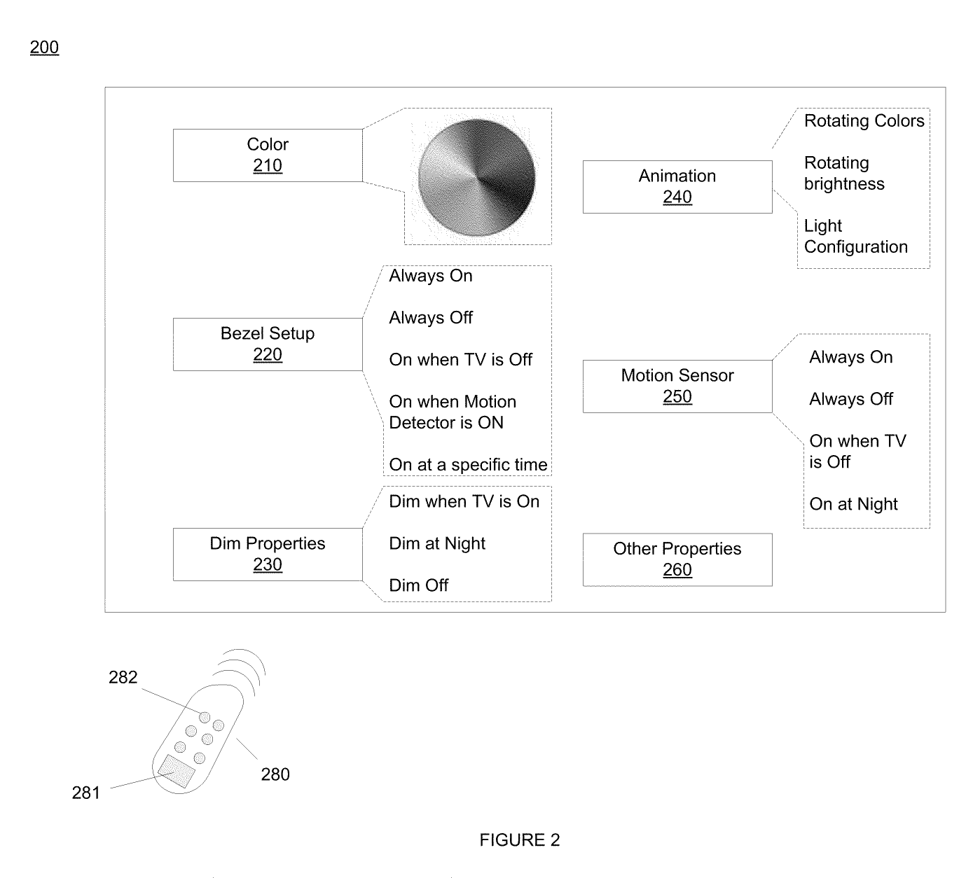

The plurality of LEDs 120 may include red, green, and blue (RGB) LEDs thereby operable to produce any color. According to one embodiment, the plurality of LEDs 120 may be disposed in a ring of LEDs that surround the display 110. It is appreciated that the plurality of LEDs 120 is user controllable and user selectable as described herein. For example, the user may select the color of the light output, its brightness, its timing, etc. The output color from the plurality of LEDs 120 is user controllable and not necessarily dependent on the content being rendered by the display 110. However, it is appreciated that the plurality of LEDs 120 may be controlled to output light that is content dependent as well. In one exemplary embodiment, a user may select the color of the light output based on user preferences and the decor of the room, thereby enhancing user viewing experience. Controlling the operation of the plurality of LEDs 120 in accordance with embodiments of the present invention is described in more detail with respect to FIG. 2 below.

The output color from the plurality of LEDs 120 is transmitted using the light pipe 130. The light pipe 130 is used to convey light without leakage from a source to a remote position of the display 110. For example, the light pipe 130 may comprise a fiber optic. The light pipe 130 is operable to drive the light out of the edge of the bezel without creating a hot spot along the edges. It is appreciated that diffusive material may be used to display the output color in a well known fashin instead of using the light pipe 130.

Referring to FIG. 2, an exemplary on-screen graphical user interface (GUI) 200 for controlling edge lighting of a television set in accordance with one embodiment of the present invention is shown. The GUI 200 may be rendered by the display 110 of the television set 100. User interaction with the GUI 200 is operable to control and define the operation of the plurality of LEDs 120 in various user selectable modes.

According to one embodiment, the GUI 200 includes a plurality of selectable icons, e.g., color 210, bezel setup 220, dim properties 230, animation 240, motion sensor 250, and other properties 260. A user may navigate the selectable icons of the GUI 200 using a remote control 280 or other means, e.g., touch screen, keyboard, mouse, etc. As a result, the operation of the plurality of LEDs 120 may be controlled, e.g., programmed, in accordance with user preferences using the GUI 200. It is appreciated that the selectable icons and their corresponding functionalities are exemplary and not intended to limit the scope of the embodiments. For example, additional selectable icons may be presented to provide a user with more options to control the operation of the bezel lighting.

It is appreciated that a selection of a selectable icon of the GUI 200 may provide the display and/or interaction of additional selectable items using a pop up window, a drop down menu, etc. According to one embodiment, selecting the color 210 icon displays a color wheel to the user. As such, a desired color for the output light may be selected. It is appreciated that more than one color may be selected for animation purposes. For example, a series of colors may be selected such that the output light changes color based on the selected sequence.

Selection of the bezel setup 220 icon may provide a plurality of further menu options to the user, e.g., “always on,” “always off,” “on when TV is off,” “on when motion detector is on,” and “on at night.” Selection of “always on” option maintains a light output from the bezel whether the television is on or off. On the other hand, selection of “always off” disables the light output from the bezel. It is appreciated that in one embodiment of the present invention the default mode may be “always off” in order to save power and maintain the Energy Star Compliant rating of the television set.

It is appreciated that the bezel lighting may be turned on only when the television is off. Accordingly, the light output does not distract the user when content is being rendered by the display 110. Moreover, turning on the bezel lighting when the television set is off may be desirable in order to match the color of the light output with the color of the surrounding decor, thereby improving the room decor and the user experience, thereby turning the television set into a decorative item.

According to one embodiment, the bezel lighting may be turned on when motion is detected. For example, a motion detector within the television set 100 may be used to detect motion nearby and turn on the light output of the bezel responsive thereto. It is appreciated that in one embodiment, the light output may be turned on based on the time of day, e.g., night-time, day-time, time elapsed from a given event, etc.

Selection of the dim properties 230 icon of FIG. 2 may provide additional selectable menu options. For example, the user may select to dim the light output when the television set is on, or dim the light output at night, or to disable the dimming capability all together.

In one embodiment, selection of the animation 240 icon may enable a user to configure the bezel to output light animation in a variety fashion. For example, selecting the animation 240 icon enables the bezel colors to be rotated over time, e.g., from white to black, in a round-robin fashion. It is appreciated that the animation colors are user selectable, e.g., by using the color wheel. Similarly, the bezel brightness may be controlled over time, e.g., rotating from brightest to dimmest, in a round-robin fashion.

According to one embodiment, the light output from the bezel may be configured, e.g., light sequencing, light colors, light brightness, timing or any combination thereof. As such, sequencing the on/off state of the plurality of LEDs 120, their respective colors and their brightness over time appears as an animation. In other words, any combination of LED colors with a different or the same brightness may be turned on/off to appear as an animation. For example, different colors of light output may snake around the display 110. In one embodiment, the same color of light may snake around the display 110. Other embodiments may employ different brightness values as the light output snakes around the display 110. In one exemplary embodiment, the light output is turned on sequentially and kept on until the last LED is turned on before the first LED that was turned on changes color, brightness, or turned off, etc. Accordingly, a sequence of specific LEDs may be selected, their colors may be configured, their brightness may be adjusted and their timing may be altered based on user preferences.

Selection of the motion sensor 250 icon of FIG. 2 may provide a user with additional options. For example, the motion sensor may always be turned on/off. In one exemplary embodiment, the motion sensor may be turned on when the television set 100 is off and/or during night-time. In other words, the timing of when the motion sensor is enabled may be controlled by the user. For example, the user may enable the motion sensor at night-time such that the light output is turned on when the user walks into the room, thereby eliminating the need to turn on any additional light.

Selection of the “other properties” 260 icon may provide additional options, e.g., timing, sequencing of the plurality of LEDs 120 and their colors along with their brightness, etc. In one exemplary embodiment, other properties icon 260 provides the user with the option to turn on specific colors, brightness values, etc. based on, or independent of, the content being rendered by the display 110.

It is appreciated that the user may further control the operation of the bezel lighting using the remote control 280 without using the GUI 200. For example, selecting an “on” button 282 on the remote control may turn on the bezel light without interacting with the GUI 200. Accordingly, it is appreciated that programming and controlling the operation of the bezel using the particular GUI 200 shown in FIG. 2 is exemplary and not intended to limit the scope of the present invention. It is appreciated that the GUI 200 may be rendered on a display 281 of the remote control 280. For example, the display 281 may comprise soft buttons for marking user selection in order to control the operation of the bezel lighting.

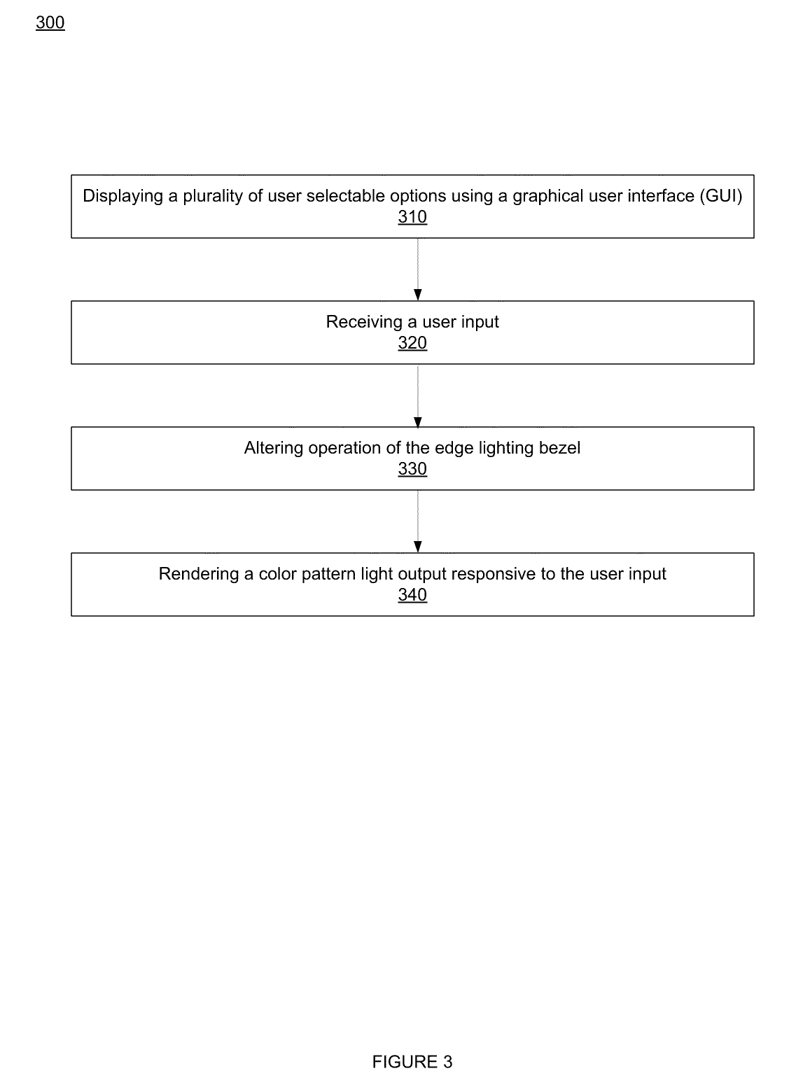

Referring to FIG. 3, an exemplary flow diagram 300 for controlling edge lighting of a television set in accordance with one embodiment of the present invention is shown. At step 310, a plurality of user selectable options is displayed to the user on screen. For example, the GUI 200 may include the user selectable options that are displayed to the user via the display 110, as discussed with respect to FIGS. 1 and 2. At step 320, one or more user selections are received. For example, the user may navigate the GUI 200 and make one or more user selections using navigation buttons on the remote control 280. It is appreciated that user selectable options may be presented on the remote control instead of the GUI 200 displayed by the television set, e.g., an on/off button 282 to power the edge lighting bezel, soft buttons 281 displayed on the remote control 280, use of a small display 281 on the remote control 280, etc.

At step 330, the operation of the edge lighting bezel may be altered in response to the received user input. For example, the user input is operable to control the operation of the edge lighting bezel surrounding the display. For example, the user input may dim the light output, select a color pattern for the light output, turn on the light output responsive to detecting a motion, turn on the light output responsive to an event, e.g., time, disable the light output, turn on the light output when the television set is off, etc.

At step 340, a color pattern of light that is responsive to the user input is rendered by the bezel. For example, the edge lighting bezel outputs a green light responsive to a user selection of green light to be output and turns on the edge lighting bezel in that fashion. It is appreciated that the edge lighting bezel may be disabled in its default mode in order to maintain Star compliance ratings.

Accordingly, the operation of the edge lighting of the television set may be altered responsive to user preferences and the room decor. As such, the television set becomes not only functional but rather decorative and enhances the user experience by improving the room decor.

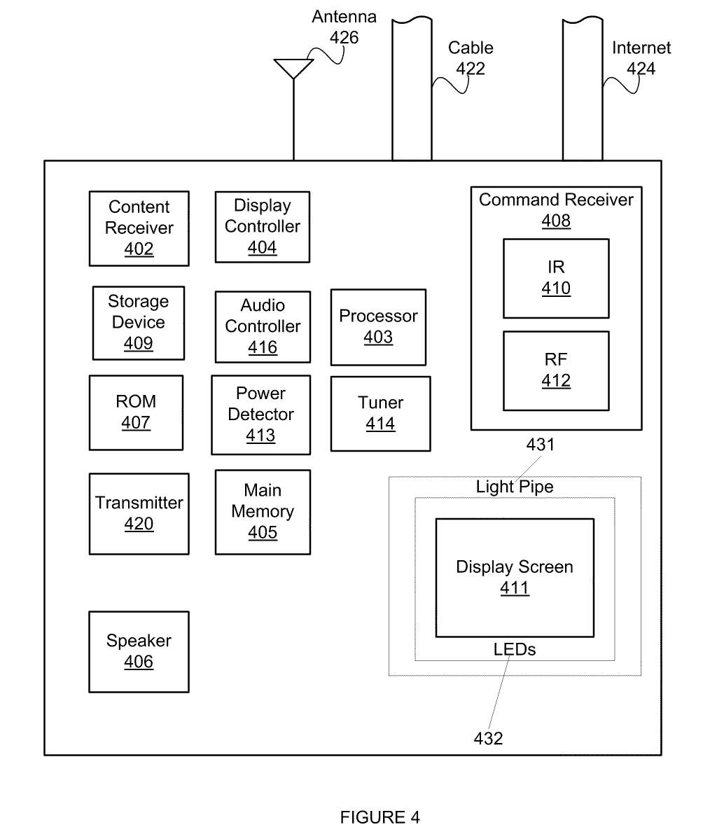

FIG. 4 illustrates components of an exemplary computer controlled television set 400 that may serve as a platform for embodiments of the present invention. Although specific components are disclosed in system 400 it should be appreciated that such components are exemplary. That is, embodiments of the present invention are well suited to having various other components or variations of the components recited in system 400. The exemplary television set 400 implements the process for controlling edge lighting as shown in FIGS. 1-3 and includes a processor 403 for processing information and a tuner 414 for tuning the television set 400 to detect channels and signals associated therewith. It is appreciated that the tuner 414 may also convert the detected channel signals into a suitable form that is appropriate for processing by the processor 403.

The exemplary television set 400 also includes a main memory 405, such as a random access memory (RAM) or other dynamic storage device for storing information and instructions to be executed by processor 403. Main memory 405 also may be used for storing temporary variables or other intermediate information during execution of instructions to be executed by processor 403. The exemplary television set 400 further includes a read only memory (ROM) 407 or other static storage device for storing static information and instructions for processor 403. A non-volatile storage device 409, such as a magnetic disk or optical disk, may be provided for storing information and instructions and may store the persistent internal queue. According to one embodiment, the instructions for implementing the bezel lighting operations may be stored on any one of the memory components (e.g., RAM, ROM, non-volatile storage device and etc.). The exemplary television set 400 may comprise a display screen 411 for displaying content.

The display screen 411 further includes a plurality of light emitting diodes 432 surrounding the display. The light emitting diodes 432 operate substantially similar to that of FIG. 1, as presented above. The light emitting diodes 432 are surrounded by the light pipe 431 that operates substantially similar to that of FIG. 1, as presented above. It is appreciated that a user controls the operation of the light emitting diodes 432 by programming the processor 403.

The term “computer-readable medium” as used herein refers to any medium that participates in providing instructions to processor 403 for execution. Such a medium may take many forms, including but not limited to, non-volatile media, volatile media, and transmission media. Non-volatile media includes, for example, optical or magnetic disks, such as storage device 409. Volatile media includes dynamic memory, such as main memory 405. Transmission media includes coaxial cables, copper wire and fiber optics, including the wires. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer or a television set can read.

The exemplary television set 400 may also include a power detector 413. The power detector 413 may be used to determine whether the television set is in a fully power mode, e.g., on, or at a lower power mode, e.g., standby, off, etc. The system 400 may further include content receiver 402, display controller 404, command receiver 408, audio controller 416, transmitter 420, cable or satellite connection 422, internet or LAN connection 424, and wireless antenna 426. The exemplary television set 400 may also include a speaker 406 for rendering audio outputs.

Content receiver 402 receives content for system 400. Receiver 402 may receive signals including content from a variety of sources including, but not limited to, computers, computer networks, portable devices, set-top boxes, over the air broadcasts, cable broadcasts, satellite broadcasts, Digital versatile Discs (DVDs), Blue-ray discs, Digital Video Broadcasting—Handheld (DVB-H), Digital Multimedia Broadcasting (DMB), Digital Video Broadcasting Satellite services to Handhelds (DVB-SH), Digital Audio Broadcasting (DAB), Digital Video Broadcasting IP Datacasting (DVB-IPDC), Internet Protocol Television (IPTV), etc. Content receiver 402 may receive content (e.g., electronic programming guide information and other content) via cable or satellite connection 422, internet connection 424, and wireless antenna 426 (e.g., via 802.11a/b/g/n, Bluetooth, Z wave, Digital Broadcast, etc.).

Display controller 404 controls display screen 411 of system 400. Display controller 404 may control a variety of display screens associated with system 400, including but not limited to, CRTs, LCDs, plasma displays, projection based, and Digital Light Processing (DLP) displays.

Command receiver 408 receives commands. Command receiver 408 may receive commands via a variety of receivers including, but not limited to, infrared receivers and radio frequency receivers. The commands may have been issued via a remote control. In one embodiment, command receiver 408 includes an infrared (IR) receiver 410 and a radio frequency (RF) receiver 412.

The processor 403 processes commands received by system 400 via command receiver 408. The commands received are processed and executed by system 400. For example, control codes (e.g., increase volume, change channel, launch an application, launch web browser, etc.) may be received via an infrared receiver 410 or radio frequency receiver 412, decoded, and sent to the processor 403. Moreover, the received command may include user preferences, e.g., user selection using the GUI described in FIG. 2, for setting up the operation of the bezel around the display screen 411.

Audio controller 416 controls audio output for system 400 including a variety of outputs including, but not limited to, 2, 2.1, 3.1, 5.1, 6.1, 7.1, and 8.1 channel audio. The audio content may be received via content receiver 402. It is appreciated that audio controller 316 may output to audio equipment integrated within system 400.

Transmitter 420 may send signals to a control device (e.g., remote control). The signals may include, but are not limited to, acknowledgments, EPGs (e.g., for download to a remote control) encrypted information, and information based on on-screen selections.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A television set comprising:
a display for rendering images;
an edge lighting bezel surrounding said display, wherein operation of said edge lighting bezel is user controllable, and wherein said edge lighting bezel is operable to output light;
a processor for processing data, wherein said processor is operable to control said operation of said edge lighting bezel in response to user input; and
a memory component operable to store information operable to control said operation of said edge lighting bezel when processed by said processor.

2. The television set as described in claim 1, wherein said edge lighting bezel is user controllable via interactions with on-screen items of a graphical user interface (GUI) displayed on said display via a remote control.

3. The television set as described in claim 1, wherein said edge lighting bezel comprises:
a plurality of light emitting diodes (LEDs) surrounding said display, wherein said plurality of LEDs is operable to emit light responsive to said user input; and
a light pipe surrounding said plurality of LEDs, wherein said light pipe is operable to transmit light emitted from said plurality of LEDs.

4. The television set as described in claim 1, wherein said operation of said edge lighting bezel is disabled in a default mode.

5. The television set as described in claim 1, wherein said operation of said edge lighting bezel dims light output from said edge lighting bezel responsive to a user defined event.

6. The television set as described in claim 5, wherein said user defined event is time based.

7. The television set as described in claim 1, wherein said operation of said edge lighting bezel emits light from said edge lighting bezel when said television set is turned off.

8. The television set as described in claim 1, wherein said operation of said edge lighting bezel is user programmable.

9. The television set as described in claim 1 further comprising:
a motion sensor operable to control said operation of said edge lighting sensor responsive to detecting motion.

10. The television set as described in claim 1, wherein said operation of said edge lighting bezel displays a user selectable color pattern on said edge lighting bezel.

11. The television set as described in claim 10, wherein said color pattern is independent of content contemporaneously rendered by said display.

12. A method of controlling edge lighting of a television set, said method comprising:
receiving user input, wherein said user input is operable to control operation of an edge lighting bezel surrounding a display of said television set;
altering a mode of operation of said edge lighting bezel responsive to said user input; and
rendering a color pattern of light from said edge lighting bezel responsive to said user input, wherein said color pattern of light is user selectable.

13. The method as described in claim 12, wherein said receiving comprises:
displaying a plurality of user selectable options of a graphical user interface (GUI) on said display, wherein said plurality of user selectable options is operable to control said operation of said edge lighting bezel.

14. The method as described in claim 12, wherein said operation of said edge lighting bezel is disabled in a default mode of operation.

15. The method as described in claim 12 further comprising:
dimming said color pattern of light responsive to a user defined event.

16. The method as described in claim 12 further comprising:
changing a current operating status of said edge lighting bezel responsive to motion detection, wherein said changing is based on said user input.

17. A computer readable medium comprising instructions that when executed implement a method of controlling edge lighting of a television set, said method comprising:
receiving user input, wherein said user input is operable to control operation of an edge lighting bezel surrounding a display of said television set;
altering a mode of operation of said edge lighting bezel responsive to said user input; and
rendering a color pattern of light on said edge lighting bezel responsive to said user input, wherein said color pattern of light is user selectable.

18. The computer readable medium as described in claim 17, wherein said receiving further comprises:
displaying a plurality of user selectable options on said display in a graphical user interface (GUI), wherein said plurality of user selectable options is operable to control said operation of said edge lighting bezel.

19. The computer readable medium as described in claim 17, wherein said operation of said edge lighting bezel is disabled in a default mode of operation.

20. The computer readable medium as described in claim 17, wherein said method further comprises:
dimming said color pattern of light responsive to a user defined event.

21. The computer readable medium as described in claim 17, wherein said method further comprises:
changing a current operating status of said edge lighting bezel responsive to motion detection, wherein said changing is based on said user input.
